(19) United States
(12) Patent Application Publication
(10) Pub. No.: US 2026/0237320 A1
(43) Pub. Date: Aug. 13, 2026

(54) SIMULATING PARTICIPANTS IN VIRTUAL REALITY GROUP STUDY SESSIONS

(71) Applicant: INTERNATIONAL BUSINESS MACHINES CORPORATION, Armonk, NY (US)

(72) Inventors: Aaron Keith Baughman, Cary, NC (US); Sarbajit Kumar Rakshit, Kolkata (IN); Jonathan Cottrell, Canandaigua, NY (US); Carolina Garcia Delgado, Zapopan (MX)

(21) Appl. No.: 19/053,032

(22) Filed: Feb. 13, 2025

(51) Int. Cl. G09B 9/00; G06N 3/0455; G06T 11/00; G06F 40/40

(52) U.S. Cl. CPC G09B 9/00; G06N 3/0455; G06T 11/00; G06F 40/40

(57) ABSTRACT

Systems, methods, and computer program products of providing simulated participants within a virtual reality environment are disclosed. In various embodiments, a first user profile comprising information characterizing previous activity of a first user in a virtual reality environment is read; a request to initiate a group study session in the virtual reality environment is read; the first user profile is provided as input to at least one machine learning model; a caption characterizing at least one simulated user is read, the caption being generated by the at least one machine learning model; the caption is provided as input to a diffusion model; a representation of the virtual reality environment is read, the representation being generated by the diffusion model, the representation depicting at least the at least one simulated user; and the representation is presented to the first user via a virtual reality device.

### BACKGROUND

Embodiments of the present disclosure relate to virtual reality environments, and more specifically, to providing simulated participants within a virtual reality environment.

### BRIEF SUMMARY

According to embodiments of the present disclosure, systems, methods of, and computer program products for providing simulated participants within a virtual reality environment are disclosed. In various embodiments, a first user profile is read comprising information characterizing previous activity of a first user in a virtual reality environment. A request to initiate a group study session in the virtual reality environment is read. The first user profile is provided as input to at least one machine learning model. A caption characterizing at least one simulated user is read. The caption may have been generated by the at least one machine learning model based on the input thereto. The caption is provided as input to a diffusion model. A representation of the virtual reality environment is read. The representation may have been generated by the diffusion model based on the input thereto. The representation may depict at least the at least one simulated user. The representation is presented to the first user via a virtual reality device.

### BRIEF DESCRIPTION OF THE DRAWINGS

FIG. 1 is a flow diagram depicting an exemplary method for providing simulated participants within a virtual reality environment, in accordance with one or more embodiments of this disclosure.

FIG. 2 is a flow diagram depicting an exemplary method for providing simulated participants within a virtual reality environment, in accordance with one or more embodiments of this disclosure.

FIG. 3 is a schematic view of an exemplary machine learning model, in accordance with one or more embodiments of this disclosure.

FIG. 4 depicts a computing node according to one or more embodiments of the present disclosure.

### DETAILED DESCRIPTION

Education in virtual reality (VR) refers to the use of immersive technology to create educational experiences that take place in a virtual or simulated environment. Using VR technology, learners can interact with virtual objects, environments, and scenarios that replicate real-world situations and challenges. Using VR technology, educators can create engaging, interactive, and personalized learning experiences that go beyond traditional classroom settings. For example, learners can explore historical landmarks, perform virtual dissections, practice language skills with native speakers, or even take part in collaborative problem-solving exercises with peers from around the world. Group learning, also known as collaborative learning, refers to an educational approach in which students work together in small groups to achieve learning objectives. Group learning involves active participation, interaction, and cooperation among group members. However, when a student wants or needs to participate in a group study session, there may not be any other available students to participate. Systems, methods, and computer program products for providing simulated students in virtual reality group study sessions are described herein. Particularly, the generation of such simulated student may comprise dynamically adopting personality profile of virtual student avatars to maximize the outcome of group study with generative AI.

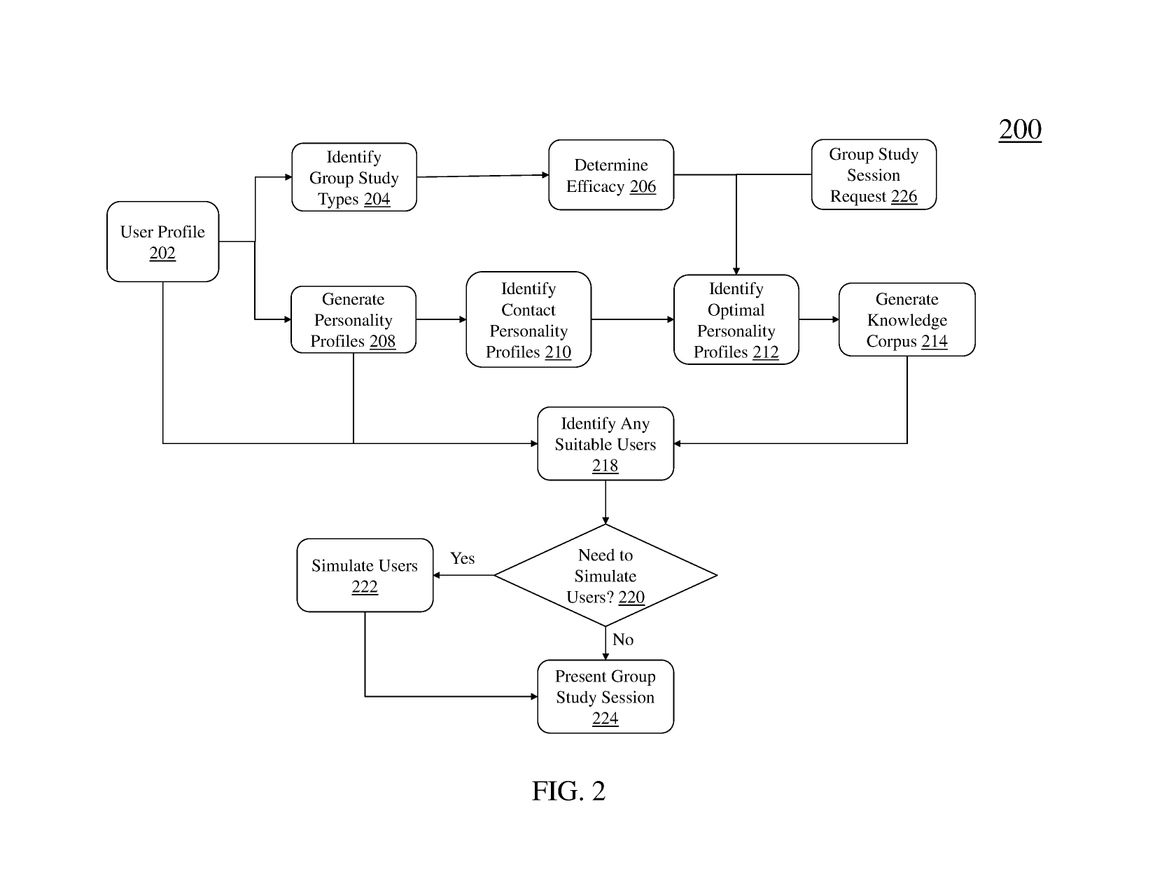

FIG. 2 is a flowchart illustrating an exemplary method 200 for providing simulated participants within a virtual reality environment is depicted. The operations of method 200 presented below are intended to be illustrative. In some implementations, method 200 is accomplished with one or more additional operations not described and/or without one or more of the operations discussed. The operations of method 200 may be performed in another order. Additionally, the order in which the operations of method 200 are illustrated in FIG. 2 and described below is not intended to be limiting.

In some implementations, method 200 is implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 200.

Operation 200 may comprise providing reading user profile 202. User profile 202 may characterize activity of a user. The activity of the user may comprise interactions between the user and another user in the virtual reality environment. The other user may be real or simulated. User profile 202 may comprise one or more of characterizations of user activity in the virtual reality environment, characterizations of user activity outside of the virtual reality environment, social media activity (e.g., the user’s posts, comments, and reactions), chat history, user preference(s), a personality profile for the user, the user’s education, and/or other information. The social media activity may be on one or more social media platforms. For example, at least one social media platform is a social media platform for an educational entity which the user is or was a part of. For example, the educational entity is a school. The educational entity may facilitate the virtual reality environment. The user activity in the virtual reality environment may comprise the user and/or an avatar associated with the user interacting with another avatar within the virtual reality environment. The chat history may comprise messages sent to and/or messages sent by the user. The characterization of the user’s education may indicate a level of education, a history of the user’s grades, a current enrollment status of the user, information characterizing the user’s strengths and/or weaknesses in education, and/or other information. User profile may comprise one or more of text, audio, visual frames, and/or other forms of information. Operation 204 may comprise identifying group study types based on at least user profile 202. Operation 200 may comprise continuously reading user profile 202. Continuously reading user profile 202 may comprise reading characterizations of user activity as the activities are performed. For example, user profile 202 is generated and/or expanded as characterizations are read.

Each group study session may be associated with session information. The session information for a group study session may identify one or more attendees of the session, one or more subjects or topics discussed during the group study session, one or more activities of the session, a size of the study group, and/or other characteristics of the study group. Operation 204 may comprise identifying group study types for one or more group study sessions. The user may have participated in and/or attended the one or more group study sessions. For example, user profile 202 may characterize the one or more group study sessions. The type of a group study session may characterize one or more of topic(s) discussed during the session, an activity of the session, a size of the study group, types of participants of the session, and/or other characteristics of the study group. In some implementations, the type of each of the one or more group study sessions is determined based on the session information for that group study session. During a group study session one or more activities may be conducted. For example, an activity may be to work on and/or discuss a worksheet, a homework assignment, an upcoming test, and/or another topic. Operation 206 may comprise determining the efficacy of each of the one or more group study sessions. Operation 206 may comprise determining the efficacy of each type of group study session. For example, the efficacy of a group study session may be a quantitative representation of whether the user learned and/or made progress on an assignment or topic during the group study session.

Operation 208 may comprise generating personality profiles. A personality profile may be generated for each user of the virtual reality environment. The personality profile for each user may be generated based on that user’s user profile. For example, the personality profile for the user is generated based on user profile 202. A personality profile refers to a description or assessment of an individual's characteristic patterns of thoughts, feelings, and behaviors that distinguish them from others. It provides insights into an individual's personality traits, tendencies, and preferences.

Each personality profile may be generated using one or more of self-report questionnaires, interviews, behavioral observations, assessments, and/or other methods. The generation of each personality profile may capture different dimensions of a user’s personality. The different dimensions of personality may comprise one or more of traits, values, attitudes, motivations, interpersonal styles, and/or other personality characteristics.

Each personality profile may identify and/or describe personality trait(s) of a user or any other individual. Traits may be enduring patterns of behavior, emotions, and thoughts that are relatively stable over time. Exemplary traits comprise extraversion, agreeableness, conscientiousness, neuroticism, and openness to experience. Traits may characterize how individuals typically interact with others, approach tasks, regulate emotions, and make decisions.

Operation 210 may comprise identifying contact personality profiles. The contact personality profiles may be personality profiles for contacts of the user. The user’s contacts may be other users with whom the user has interacted within and/or outside of the virtual reality environment. The contact personality profiles may be identified based on one or more of user profile 202, the personality profiles, and/or other information.

Operation 212 may comprise identifying optimal personality profiles. The optimal profiles may be identified based on one or more of user profile 202, contact personality profiles, the identified efficacies, group study session request 226, and/or other information. Group study session request 226 may be read responsive to receiving input indicating the request. The input may have been provided by the user via a client computing platform. For example, the input was provided by the user via a virtual reality device. Group study session request 226 may identify a topic for a group study session to be initiated. Identifying the optimal personality profiles may comprise determining a subset of the user’s contacts with whom the user had efficient group study sessions. Identifying the optimal personality profiles may comprise identifying the personality profile for each user of the subset of the user’s contacts. Identifying the optimal personality profiles may comprise identifying one or more personality profiles indicating one or more traits of users with whom the user has had at least one effective group study session.

Operation 214 may comprise generating a knowledge corpus based on one or more of the optimal personality profiles, the contact personality profiles, the user’s personality profile, user profile 202, group study session request 226, and/or other information. For example, the knowledge corpus identifies an optimal study group size for the user. For example, the knowledge corpus identifies the optimal personality profiles. For example, the knowledge corpus identifies optimal study group type(s) for the user.

Operation 218 may comprise identifying any suitable users. A suitable user may be a user that satisfies one or more of the following: is currently active in the virtual reality environment, is not currently participating in another activity, is not scheduled to be participating in another activity at the same time as the group study session, and/or has an optimal personality profile. In some implementations, no suitable users are identified by virtue of there not being any suitable users. In some implementations, identifying any suitable users comprises determining a count of suitable users.

Operation 220 may comprise determining whether there is a need to simulate any users to initiate the group study session. The determination may be made based on one or more of the identified suitable users, the count of suitable users, group study session request 226, and/or other information. The determination may comprise determining a count of users to simulate. The count of users to simulate may be determined based on group study session request 226, the knowledge corpus, user profile 202, the determined efficiencies, and/or other information. By way of non-limiting example, operation 220 comprises determining there is no need to simulate any users responsive to identifying a count of suitable users greater than or equal to a threshold at operation 218. By way of non-limiting example, operation 220 comprises determining there is a need to simulate one or more users responsive to identifying a count of suitable users less than or equal to the threshold at operation 218. The threshold may be any number of users. The threshold may be identified by group study session request 226, determined based on the determined efficacies historical group study sessions, identified by the knowledge corpus, and/or determined based on other information. For example, the threshold is set such that the participants of the group study session only comprise the user and one of real user(s) or simulated user(s). In some implementations, the participants of the group study session may comprise a combination of the user, other real user(s), and simulated user(s).

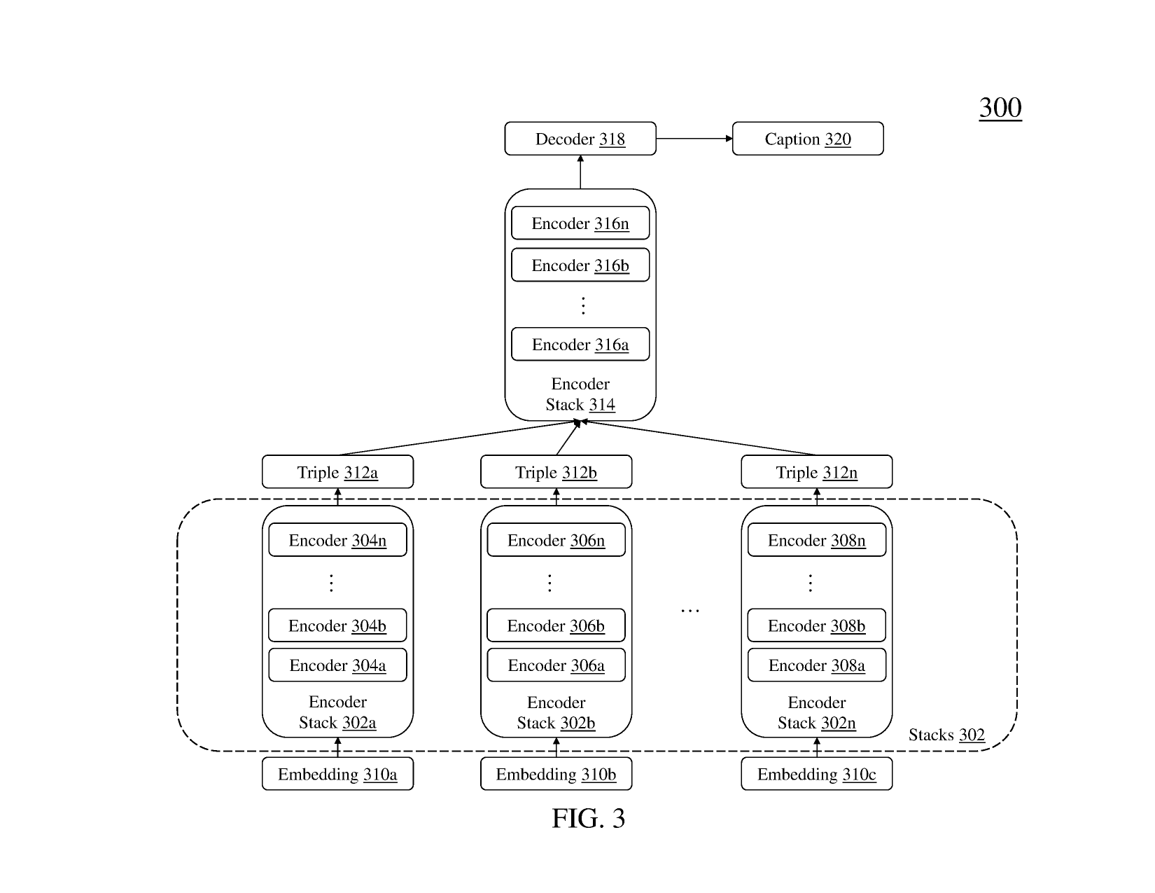

Operation 222 may comprise simulating one or more users for participation in the group study session. For example, operation 222 is performed responsive to determining there is a need to simulate users for the initiation of the group study session at operation 220. Simulating the one or more users may comprise simulating one or more users according to the count of simulated users. Simulating the one or more users may comprise generating an avatar for each of the one or more simulated users. Simulating the one or more users may comprise providing user profile 202, knowledge corpus 214, group study session request 226, user profiles for the user’s contacts, personality profiles for the user’s contacts, and/or other information as input to at least one machine learning model. For example, the one or more optimal personality profiles may be provided as input to the at least one machine learning model. The at least one machine learning model may comprise a transformer. For example, the at least one machine learning model comprises a machine learning model that is the same as or similar to machine learning model 300 depicted in FIG. 3 and described herein.

Referring now to FIG. 3, a schematic diagram for an exemplary machine learning model 300 is depicted. Machine learning model 300 may comprise stacks 302, encoder stack 314, and decoder 318. Stacks 302 may comprise encoder stacks 302a-302n. Machine learning model 300 may comprise at least one encoder stack. Each encoder stack 302a-302n and encoder stack 314 may comprise at least one encoder. Encoder stack 302a may comprise encoders 304a-304n. Encoder stack 302b may comprise encoders 306a-306n. Encoder stack 302n may comprise encoders 308a-308n. Encoder stack 314 may comprise encoders 316a-316n. Each encoder stack may be configured to receive an embedding as input.

The encoders in each of encoder stacks 302a-302n and encoder stack 314 may be organized as a sequence of encoders. Input to stack of stacks 302 may be passed to the first encoder of that stack. Encoder stack 302a, encoder stack 302b, and encoder stack 302n may be configured to individually pass their respective inputs as input to the first encoder of its encoder sequence. For example, encoder 304a, encoder 306a, and encoder 308a are configured to receive embedding 310a, embedding 310b, and embedding 310c (respectively). For example, encoder stacks 302a-302n are configured to receive embeddings 310a-310n respectively. Each of embeddings 310a-310n may be machine-readable characterizations of the input to machine learning model 300. The output of the final encoders of encoder stacks 302a-302n and encoder stack 316n (e.g., encoders 304n, 306n, 308n, and 316n) may be output of their respective encoder stacks 302a-302nand encoder stack 314. The output of the other encoders may be provided as input to the next encoder in its sequence. For example, the output of encoder 304ais provided as input to encoder 304b. For example, encoder stacks 302a-302n and encoder stack 314 may be configured to perform similarly to or in the same way as the encoder stack of a transformer model.

Each stack of stacks 302 may be configured to generate and/or output a key, a value, and a query. The key, the value, and the query generated by an individual stack of stacks 302 may be concatenated to form a triple. For example, each triple represents the query, the value, and the key for an individual stack of stacks 302. The query, the value, and the key may comprise representations derived from the input to machine learning model 300. The query may comprise a query vector for each token of the input to machine learning model 300. The value may comprise a value vector for each token of the input to machine learning model 300. The key may comprise a key vector for each token of the input to machine learning model 300. The key, the query, and the value may be the same as or similar to key, queries, and values generated by the encoder of a traditional transformer architecture. In some implementations, encoder stacks 302a-302n may be configured to output triples 312a-312n, respectively.

Machine learning model 300 may be configured to provide triples 312a-312n as input to encoder stack 314. In some implementations, one of triples 312a-312n is provided to encoder stack 314 at a time. In some implementations, two or more triples 312a-312n are provided to encoder stack 314 simultaneously. Encoder stack 314 may be configured to generate and/or output caption 320 based on at least one of triples 312a-312n. Machine learning model 300 may be configured to generate and/or output caption 320. For example, caption 320 may be generated by decoder 318. In some implementations, each encoder stack of stacks 302 is associated with a user of the virtual reality environment. For example, encoder stack 314 may be generated based on stacks 302. For example, encoder stack 314 may be a merging of stacks 302.

Referring back to FIG. 2, the at least one machine learning model may comprise an encoder stack for each user of the virtual reality environment. The encoder stack for an individual user may be associated with that user. For example, each of encoder stacks 302a-302n (depicted in FIG. 3 and described herein) are associated with a user of the virtual reality environment. For example, encoder stack 302a is associated with the user, encoder stack 302b is associated with a second user, and encoder stack 302n is associated with an n^{th} user. In some implementations, the encoder stack for each user was trained using the user profile and/or the knowledge corpus for that user. The at least one machine learning model may comprise a merged encoder stack associated with all users of the virtual reality environment. For example, encoder stack 314 (depicted in FIG. 3) is associated with all users of the virtual reality environment. In some implementations, simulating the one or more users comprises providing group study session request 226 and user profile 202 as input to the encoder stack associated with the user.

The encoder stack associated with the user may be configured to generate a triple characterizing a query, a value, and a key. The triple may be provided as input to the merged encoder stack. The merged encoder stack may be configured to generate hidden state vectors and/or an attention mask as output based on the input thereto. The output of the merged encoder stack may be provided to the decoder. The decoder may be configured to generate a caption based on the input thereto. The caption may be a characterization of at least one simulated user. For example, the caption may characterize an avatar and/or a personality for the at least one simulated user. For example, a simulated user has a personality profile identified as an optimal personality profile. For example, a simulated user has a personality profile that is similar to, a combination of, and/or generated based on one or more personality profiles identified as optimal. For example, a simulated user has a personality profile that is the same as, similar to, and/or generated based on at least the user’s personality profile. In some implementations, a separate caption may be generated and/or read for each simulated user.

Simulating the one or more users may comprise reading the caption. Simulating the one or more users may comprise providing the caption and one or more visual frames of the virtual reality environment as input to a diffusion model. For example, the caption and a stream of one or more visual frames may be provided as input to the diffusion model. The diffusion model may be configured to generate output of a plurality of modalities. The output of the diffusion model may be a representation of the virtual reality environment. The representation may be in the form of language, image, video, and/or audio. For example, the representation comprises a visual representation of the virtual reality environment, an audio representation of the virtual reality environment, and/or another representation. The diffusion model may be configured to include and/or change items within the virtual reality environment. The representation of the virtual reality environment may be generated at least in part based on the personality profile(s) of the one or more simulated users.

The diffusion model may be configured to generate the visual representation of the virtual reality environment. The generated visual representation may comprise generated visual frames depicting at least the one or more simulated users. For example, the generated visual frames were generated based on the input visual frames and/or other information. The generated visual frames may comprise new visual frames and/or may comprise the input visual frames with the addition of the one or more simulated users. For example, body language of a simulated user may be generated in a visual representation of the virtual reality environment based on the personality profile of the simulated user. As used herein, the body language of any simulated users and/or real users may be used to refer to the body language of an avatar representing the user in the virtual reality environment.

The diffusion model may be configured to generate the audio representation of the virtual reality environment. The audio representation of the virtual reality environment may be generated based on the caption and/or the visual frames. The audio representation may comprise ambient sounds for the virtual reality environment, vocalizations from avatars or users in the virtual reality environment, and/or other sounds from the virtual reality environment. For example, the intonation, prosody of speech, accent, and/or other audible characteristics of the simulated user may be generated in the audio representation of the virtual reality environment based on the personality profile of the simulated user.

Operation 224 may comprise presenting the group study session to the user via a virtual reality device. Presenting the group study session may comprise presenting the representation of the diffusion model via a virtual reality device. By way of non-limiting example, the virtual reality device comprises one or more of a head-mounted display (HMD), a controller and/or input device, a locomotion device, a haptic feedback device, another display, and/or another device. For example, an audio representation of the virtual reality environment generated by the diffusion model may be presented to the user via a speaker and/or another audio device.

Presenting the group study session to the user may comprise reading a stream of user input. The user input may be provided via one or more client computing platforms and/or virtual reality devices. Operation 224 may comprise reading a representation of the virtual reality environment. For example, operation 224 comprises reading a stream of frames representing the virtual reality environment during the study group session. For example, operation 224 comprises reading an audio stream of the group study session in the virtual reality environment.

Operation 224 may comprise providing the representation, user profile 202, and/or other information as input to a prompt machine learning model. The prompt machine learning model may be configured to generate a prompt for the at least one machine learning model. The prompt may be generated based on the input to the prompt machine learning model. The prompt machine learning model may be a transformer. In some implementations, the prompt comprises an indication of a question asked by and/or an answer provided by a user (simulated or real) during the study group session. In some implementations, the prompt comprises an indication of other user actions in the virtual reality environment. In some implementations, the prompt comprises an indication of a shift in a subject of the group study session. The prompt may comprise an indication for a language model to generate a natural language response to the question and/or the answer. For example, the language model is a conversational model (e.g., ChatGPT). The prompt may comprise an indication for the diffusion model to generate a response to the question and/or answer. Operation 224 may comprise reading the prompt. For example, the prompt may be a characterization of the shift.

Operation 224 may comprise providing the prompt, personality profile(s) for the one or more simulated students, and/or other information as input to the language model. Operation 224 may comprise reading a natural language response to the prompt. Operation 224 may comprise providing the prompt and/or the natural language response as input to the diffusion model. For example, operation 224 comprises providing the characterization of the shift as input to the diffusion model and/or the at least one machine learning model. Operation 224 may comprise reading at least one updated personality profile for the one or more simulated users. Reading the at least one updated personality profile may comprise reading a modified personality characteristic of the at least one simulated user. For example, the at least one updated personality profile may be generated by the at least one machine learning model based on the characterization of the shift. An updated personality profile may replace the personality profile for a simulated user. The personality profile for the simulated user may be replaced in accordance with the new topic of the group study session. The replacement may ensure compatibility of the simulated user with the user for the group study session.

Operation 224 may comprise reading an updated representation of the virtual reality environment generated by the diffusion model. The updated representation may comprise an audio representation of the natural language response according to the personality profile of a simulated student. The updated representation may depict a body language and/or audio action of the one or more simulated users responsive to an action identified by the prompt. For example, the updated representation depicts a simulated user speaking an answer to a question asked by the user.

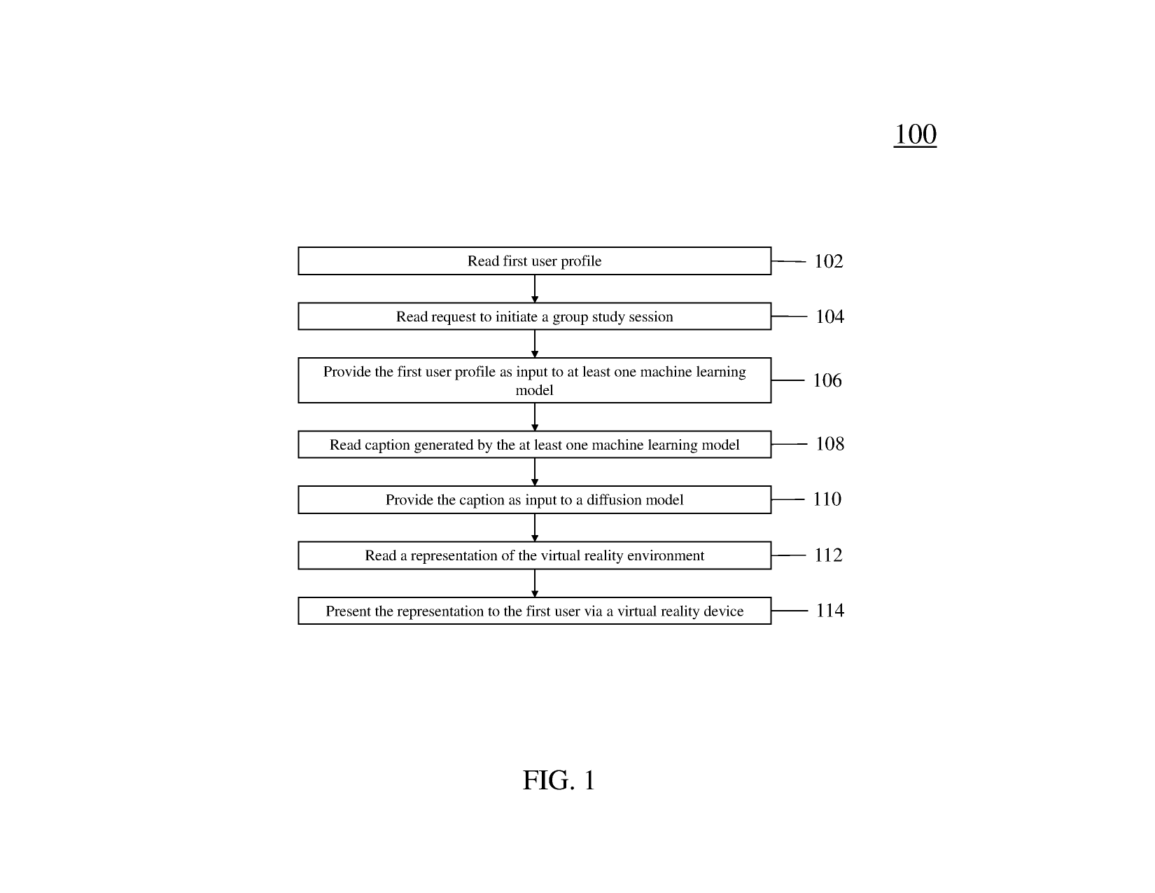

Referring now to FIG. 1 a flowchart illustrating an exemplary method 100 for providing simulated participants within a virtual reality environment is depicted. The operations of method 100 presented below are intended to be illustrative. In some implementations, method 100 is accomplished with one or more additional operations not described and/or without one or more of the operations discussed. The operations of method 100 may be performed in another order. Additionally, the order in which the operations of method 100 are illustrated in FIG. 1 and described below is not intended to be limiting.

In some implementations, method 100 is implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 100.

Operation 102 may comprise reading a first user profile. The first user profile may characterize previous activity of a first user in a virtual reality environment. Operation 104 may comprise reading a request to initiate a group study session in the virtual reality environment. Operation 106 may comprise providing the first user profile as input to at least one machine learning model. Operation 108 may comprise reading a caption. The caption may characterize at least one simulated user. The caption may have been generated by the at least one machine learning model based on the input thereto. Operation 110 may comprise providing the caption as input to a diffusion model. Operation 112 may comprise reading a representation of the virtual reality environment. The representation may have been generated by the diffusion model based on the input thereto. The representation may depict at least the at least one simulated user. Operation 114 may comprise presenting the representation to the first user via a virtual reality device.

In various embodiments, a vector of features that includes the machine learning model input(s) may be provided to one or more of the machine learning models described herein. Based on the input features, one or more of the machine learning models described herein may generate one or more outputs. In some embodiments, the output(s) of the one or more machine learning models described herein may be a vector of features.

In various embodiments, the one or more machine learning models, described herein, may be pre-trained using training data. In various embodiments, training data may be retrospective data. In various embodiments, the retrospective data may be stored in a data store. In various embodiments, the one or more machine learning models, described herein, may be additionally trained through manual curation of previously generated outputs.

In various embodiments, the one or more machine learning models, described herein, may be and/or may include a dynamic programming algorithm and/or model, such as a dynamic linear programming algorithm/model or a dynamic nonlinear programming algorithm/model. In various embodiments, the one or more machine learning models, described herein, may be a trained classifier. In various embodiments, the trained classifier may be a random decision forest. However, it will be appreciated that a variety of other classifiers are suitable for use according to the present disclosure, including linear classifiers, support vector machines (SVM), or artificial neural network models, such as generative adversarial networks (GANs) and/or recurrent neural networks (RNNs).

Suitable artificial neural network models include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

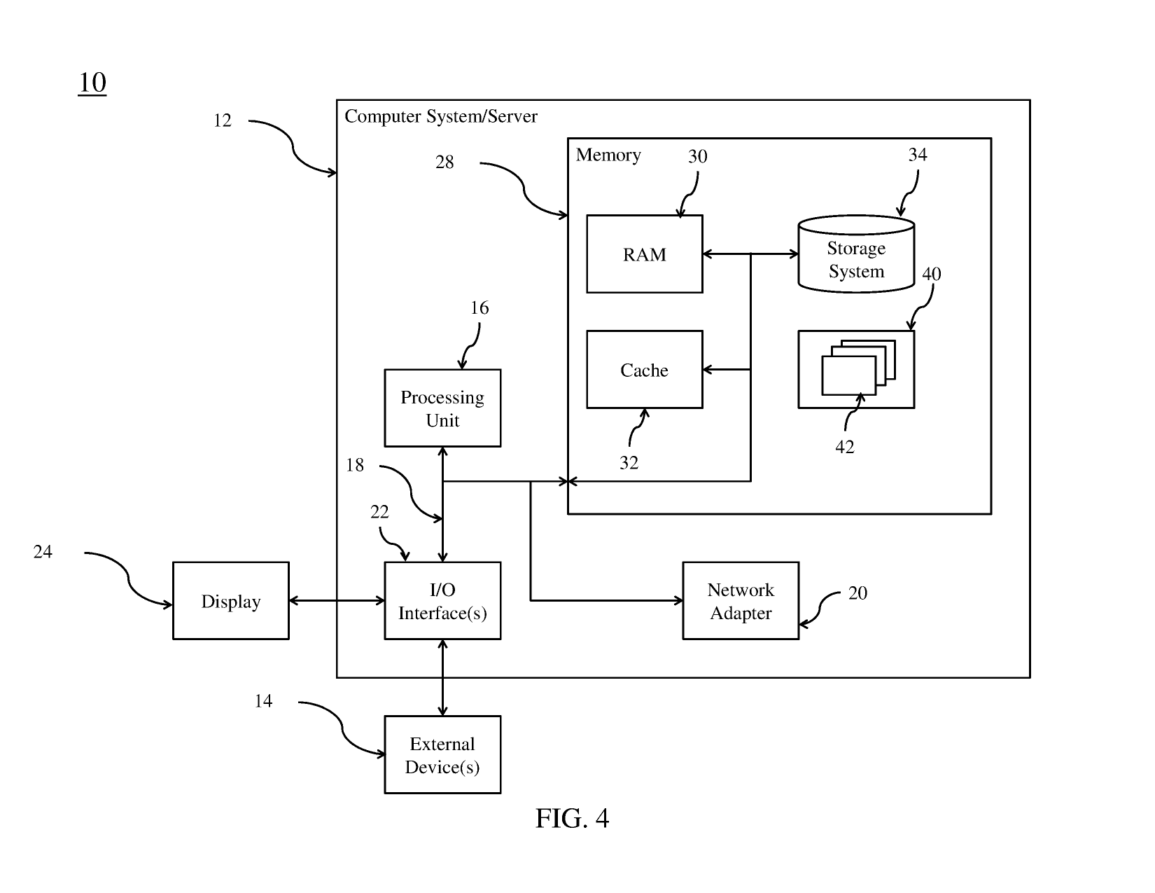

As shown in FIG. 4, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a "hard drive"). Although not shown, a magnetic disk drive for reading from and writing to a removable, non-volatile magnetic disk (e.g., a "floppy disk"), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of providing simulated participants within a virtual reality environment, the method comprising:
reading a first user profile comprising information characterizing previous activity of a first user in a virtual reality environment;
reading a request to initiate a group study session in the virtual reality environment;
providing the first user profile as input to at least one machine learning model;
reading a caption characterizing at least one simulated user, the caption being generated by the at least one machine learning model based on the input thereto;
providing the caption as input to a diffusion model;
reading a representation of the virtual reality environment, the representation being generated by the diffusion model based on the input thereto, the representation depicting at least the at least one simulated user; and
presenting the representation to the first user via a virtual reality device.

2. The method of claim 1, the method further comprising:
reading a visual representation of the virtual reality environment;
providing the visual representation and the first user profile as input to a prompt machine learning model configured to generate a prompt for the diffusion model based on the input thereto;
reading the prompt;
providing the prompt as input to the diffusion model; and
reading an updated representation of the virtual reality environment; and
presenting the updated representation to the first user via the virtual reality device, wherein
the request is a prompt generated by the prompt machine learning model.

3. The method of claim 2, wherein the prompt machine learning model is a transformer.

4. The method of claim 2, wherein the at least one machine learning model comprises a set of one or more stacks of encoders, a merged stack of encoders, and a decoder, wherein each stack of the set is associated with a user of the virtual reality environment, wherein providing the visual representation and the first user profile as input to the prompt machine learning model comprises:
providing the visual representation and the first user profile to the stack associated with the first user;
reading a triple generated by the stack based on the input thereto, the triple comprising a query, a value, and a key;
providing the triple as input to the merged stack of encoders;
reading an embedding generated by the merged stack of encoders; and
providing the embedding as input to the decoder.

5. The method of claim 1, wherein the first user profile further comprises one or more of a personality profile, a chat history of the first user, information characterizing interaction with one or more other users of the virtual reality environment, and/or education information for the first user.

6. The method of claim 5, the method further comprising:
reading interaction representations representing user interactions with other entities, wherein each interaction representation is text, audio, and/or visual; and
generating the personality profile based on the representations.

7. The method of claim 1, the method further comprising:
identifying a preferred count of participants for the group study session;
determining a count of available users, wherein each available user is available for participation in the group study session; and
determining a count of simulated users to generate based on the preferred count and the count of other users, wherein
the at least one simulated user comprises as many simulated users as the count of simulated users.

8. The method of claim 1, the method further comprising:
identifying one or more other users with whom the first user has previously interacted, wherein each of the one or more other users is associated with a user profile;
reading the user profile associated with each of the one or more other users; and
providing each user profile as input to the at least one machine learning model.

9. The method of claim 1, the method further comprising:
reading an audio representation of the group study session in the virtual reality environment;
identifying speech by the first user based on the audio representation;
generating a prompt based on the speech;
providing the prompt as input to a generative language model;
reading a response to the prompt generated by the generative language model responsive to the input thereto;
providing the response as input to the diffusion model;
reading a response representation generated by the diffusion model based on the input thereto; and
presenting the response representation to the first user via the virtual reality device.

10. The method of claim 9, the method further comprising:
identifying a shift in a subject of the group study session;
providing a characterization of the shift as input to the at least one machine learning model;
reading a caption modifying a personality characteristic of the at least one simulated user; and
providing the caption as input to a generative language model.

11. A computer program product comprising:
one or more computer-readable storage media; and
program instructions stored on the one or more computer-readable storage media to perform operations comprising:
reading a first user profile comprising information characterizing previous activity of a first user in a virtual reality environment;
reading a request to initiate a group study session in the virtual reality environment;
providing the first user profile as input to at least one machine learning model;
reading a caption characterizing at least one simulated user, the caption being generated by the at least one machine learning model based on the input thereto;
providing the caption as input to a diffusion model;
reading a representation of the virtual reality environment, the representation being generated by the diffusion model based on the input thereto, the representation depicting at least the at least one simulated user; and
presenting the representation to the first user via a virtual reality device.

12. The computer program product of claim 11, the operations further comprising:
reading a visual representation of the virtual reality environment;
providing the visual representation and the first user profile as input to a prompt machine learning model configured to generate a prompt for the diffusion model based on the input thereto;
reading the prompt;
providing the prompt as input to the diffusion model; and
reading an updated representation of the virtual reality environment; and
presenting the updated representation to the first user via the virtual reality device, wherein
the request is a prompt generated by the prompt machine learning model.

13. The computer program product of claim 12, wherein the at least one machine learning model comprises a set of one or more stacks of encoders, a merged stack of encoders, and a decoder, wherein each stack of the set is associated with a user of the virtual reality environment, wherein providing the visual representation and the first user profile as input to the prompt machine learning model comprises:
providing the visual representation and the first user profile to the stack associated with the first user;
reading a triple generated by the stack based on the input thereto, the triple comprising a query, a value, and a key;
providing the triple as input to the merged stack of encoders;
reading an embedding generated by the merged stack of encoders; and
providing the embedding as input to the decoder.

14. The computer program product of claim 11, the operations further comprising:
identifying one or more other users with whom the first user has previously interacted, wherein each of the one or more other users is associated with a user profile;
reading the user profile associated with each of the one or more other users; and
providing each user profile as input to the at least one machine learning model.

15. The computer program product of claim 11, the operations further comprising:
reading an audio representation of the group study session in the virtual reality environment;
identifying speech by the first user based on the audio representation;
generating a prompt based on the speech;
providing the prompt as input to a generative language model;
reading a response to the prompt generated by the generative language model responsive to the input thereto;
providing the response as input to the diffusion model;
reading a response representation generated by the diffusion model based on the input thereto; and
presenting the response representation to the first user via the virtual reality device.

16. A computer system comprising:
a processor set;
one or more computer-readable storage media; and
program instructions stored on the one or more computer-readable storage media to perform operations comprising:
reading a first user profile comprising information characterizing previous activity of a first user in a virtual reality environment;
reading a request to initiate a group study session in the virtual reality environment;
providing the first user profile as input to at least one machine learning model;
reading a caption characterizing at least one simulated user, the caption being generated by the at least one machine learning model based on the input thereto;
providing the caption as input to a diffusion model;
reading a representation of the virtual reality environment, the representation being generated by the diffusion model based on the input thereto, the representation depicting at least the at least one simulated user; and
presenting the representation to the first user via a virtual reality device.

17. The computer system of claim 16, the operations further comprising:
reading a visual representation of the virtual reality environment;
providing the visual representation and the first user profile as input to a prompt machine learning model configured to generate a prompt for the diffusion model based on the input thereto;
reading the prompt;
providing the prompt as input to the diffusion model; and
reading an updated representation of the virtual reality environment; and
presenting the updated representation to the first user via the virtual reality device, wherein
the request is a prompt generated by the prompt machine learning model.

18. The computer system of claim 16, wherein the at least one machine learning model comprises a set of one or more stacks of encoders, a merged stack of encoders, and a decoder, wherein each stack of the set is associated with a user of the virtual reality environment, wherein providing the visual representation and the first user profile as input to the prompt machine learning model comprises:
providing the visual representation and the first user profile to the stack associated with the first user;
reading a triple generated by the stack based on the input thereto, the triple comprising a query, a value, and a key;
providing the triple as input to the merged stack of encoders;
reading an embedding generated by the merged stack of encoders; and
providing the embedding as input to the decoder.

19. The computer system of claim 16, the operations further comprising:
identifying one or more other users with whom the first user has previously interacted, wherein each of the one or more other users is associated with a user profile;
reading the user profile associated with each of the one or more other users; and
providing each user profile as input to the at least one machine learning model.

20. The computer system of claim 16, the operations further comprising:
reading an audio representation of the group study session in the virtual reality environment;
identifying speech by the first user based on the audio representation;
generating a prompt based on the speech;
providing the prompt as input to a generative language model;
reading a response to the prompt generated by the generative language model responsive to the input thereto;
providing the response as input to the diffusion model;
reading a response representation generated by the diffusion model based on the input thereto; and
presenting the response representation to the first user via the virtual reality device.
